(19) United States
(12) Patent Application Publication
(10) Pub. No.: US 2020/0103122 A1
(43) Pub. Date: Apr. 2, 2020

(54) PAN AND EXTRACTION DEVICE FOR WORKTOP

(71) Applicant: Intell Properties B.V., Duiven (NL)

(72) Inventor: Wouter Koomen, Noordwijkerhout (NL)

(73) Assignee: Intell Properties B.V., Duiven (NL)

(21) Appl. No.: 16/617,522

(22) PCT Filed: Jun. 5, 2018
(86) PCT No.: PCT/EP2018/064784

§ 371 Date: Nov. 27, 2019

(30) Foreign Application Priority Data
Jun. 6, 2017 (NL) 2019023

(51) Int. Cl. F24C 15/20; A47J 36/38; A47J 36/32

(52) U.S. Cl. CPC F24C 15/2042; A47J 36/32; A47J 36/38

(57) ABSTRACT

Combination of an extraction device for a worktop and a pan (5), having one or more extraction openings (3) in a main surface of the worktop. An extraction motor (10) is present in communication with the extraction opening (3) via an associated extraction duct and arranged to provide an area of low pressure in the extraction opening (3) for extracting cooking fumes. An extraction area displacement element (8; 14; 15; 16; 22) is present as part of the pan (5) or as a separate part. When the pan (5) is placed on the pan support (2) during operation, the extraction area displacement element (8; 14; 15; 16; 22) is configured to move the area of low pressure to an area near a rim (7) of the pan (5) or configured to direct cooking fumes from the rim (7) of the pan (5) towards the area of low pressure.

### FIELD OF THE INVENTION

The invention relates to a combination of an extraction device for a worktop (such as a gas or induction hob) and a pan, the extraction device comprising a worktop having at least one pan support supporting the pan, wherein the worktop further comprises an extraction opening which is provided in a main surface of the worktop and arranged close to the at least one pan support, and an extraction motor in communication with the extraction opening via an associated extraction duct and arranged to provide an area of low pressure in the extraction opening for extracting cooking fumes.

### BACKGROUND ART

For kitchen applications, extraction devices are known which are mounted above a hob or cooking device and extract cooking vapours from the top side. Nowadays, extraction devices are also known which do not hang above the hob, but are integrated into a worktop, and placed, for example, around a group of cooking rings. The drawback of this variant is that, when using tall pans, it is possible that the extraction force is insufficient there, as a result of which the cooking vapours are not extracted and may end up in the surroundings. In addition, this type of extraction is often noisy, as a high extraction capacity is required.

German patent publication DE-A-10 2008 050723 discloses a cooking plate having two or more cooking fields, provided with an extraction device having openings in the surface of the cooking plate, allowing to take away cooking fumes in a downward direction. The openings are provided at edges of the cooking plate in the vicinity of the cooking fields.

### SUMMARY OF THE INVENTION

It is an object of the invention to provide an improved extraction device for a worktop, allowing an efficient and effective extraction of cooking vapours and fumes, from the worktop surface, i.e. without any extending, protruding or overhanging extraction device elements.

According to the invention, a combination of an extraction device for a worktop and a pan as described above is provided, further comprising an extraction area displacement element which, when the pan is placed on the pan support during operation. is configured to move the area of low pressure to an area near a rim of the pan or configured to direct cooking fumes from the rim of the pan towards the area of low pressure.

By moving the active extraction area (having a slightly lower pressure) and extracting locally, closer to the area where cooking vapour arises, adequately efficient and effective extraction can take place, at the same time lowering the needed capacity of the extraction motor. By having the extraction area displacement element to direct cooking fumes from the rim of the pan towards the extraction opening, it is also possible to extract cooking vapour much more effectively in a structurally similar manner. In both cases, even if the pan is tall, an improvement can be obtained with only small adaptations or additions to the combination of extraction device and pan to be used.

### SHORT DESCRIPTION OF DRAWINGS

The invention is explained below by means of the attached drawings, in which:

FIG. 1 shows a cross-sectional view of a first embodiment of the present extraction device for a worktop;

FIG. 2 shows a cross-sectional view of a second embodiment of the present extraction device for a worktop;

FIG. 3 shows a cross-sectional view of a third embodiment of the present extraction device for a worktop;

FIG. 4 shows a cross-sectional view of a fourth embodiment of the present extraction device for a worktop;

FIG. 5A-D show cross-sectional and detail views of an embodiment of a pan usable in one of the present invention embodiments;

FIG. 6 shows a cross sectional view of an alternative pan usable in one of the present invention embodiments;

FIG. 7 shows a cross sectional view of a further alternative pan usable in one of the present invention embodiments; and

FIG. 8 shows a cross sectional view of yet a further alternative pan usable in one of the present invention embodiments.

### DESCRIPTION OF EMBODIMENTS

The extraction of cooking vapours (or fumes) from a pan is usually done using an extractor hood above a hob or cooking plate. This solution is highly suitable for extracting the cooking vapours from tall pans, also without a lid. However, for aesthetic reasons there is a growing interest in worktop extraction, in other words with a means of extraction at the location of the cooking points (burners) of the hob. In the case of worktop extraction, consumers are usually advised to rest a lid on the pan at an angle in order to direct the cooking vapours towards the extraction openings.

Current devices for worktop extraction fail to efficiently extract the cooking vapours from tall pans. The extraction works with a large air flow and can be experienced as noisy, even when using a lid to guide the cooking vapours to the rim of the pan.

According to embodiments of the present invention, it is possible to solve this problem by using the pan itself in an integrated extraction arrangement. In an exemplary embodiment, the pan has the additional function of displacing the extraction point from next to the pan to the rim of the pan.

In more general terms, the present invention relates to a combination of an extraction device for a (kitchen) worktop and a pan 5, the extraction device comprising a worktop having at least one pan support 2 for supporting the pan 5, wherein the worktop further comprises an extraction opening 3 which is provided in a main surface of the worktop and arranged close to the at least one pan support 2, and an extraction motor 10 in communication with the extraction opening 3 via an associated extraction duct and arranged to provide an area of low pressure in the extraction opening 3 for extracting cooking fumes (or cooking vapours). The combination further comprises an extraction area displacement element 8; 14; 15; 16; 22 which, when the pan 5 is placed on the pan support 2 during operation. is configured to move the area of low pressure to an area near a rim 7 of the pan 5 or configured to direct cooking fumes from the rim 7 of the pan 5 towards the area of low pressure. This may be implemented in many ways, e.g. the extraction area displacement element 8; 14; 15; 16; 22 may comprise a duct like assembly in communication with the extraction opening 3, or alternatively the extraction area displacement element 8; 14; 15; 16; 22 may comprise a redirection body arranged to redirect cooking fumes from the rim 7 of the pan 5 towards the extraction opening 3.

It is noted that the extraction opening 3 may entirely surround the surface of the pan support 2 (in a concentric or rectangular manner), but may also be arranged around only part of the surface of the pan support 2, for example in the form of a straight line or concentric arc. This makes it possible to use various types and dimensions of cooking zones (for example with an induction hob). In further exemplary embodiments, the worktop comprises two or more (e.g. four, three, or five) pan supports 2, and a single extraction opening 3 is provided in the surface of the worktop symmetrically in between the two or more pan supports 2.

In one group of embodiments, the extraction area displacement element is an integral part of the pan 5, and in an alternative group of embodiments, the extraction area displacement element is a separate part, for example in the form of an extraction attachment arranged on the pan 5. Such an extraction attachment may, in an advantageous embodiment, be configured so as to be removable, in order to facilitate cleaning. In a further embodiment, it is conceivable for the extraction area displacement element to comprise a (removable) extraction attachment that can be arranged on an existing pan 5 as an accessory, i.e. for use on the pan 5.

The advantage of these embodiments is that the hob can remain completely flat, without upright edges and the like. In further embodiments, the extraction area displacement element may comprise several parts, for example an extension part placed on the extraction opening 3 or an extension part arranged on the pan 5.

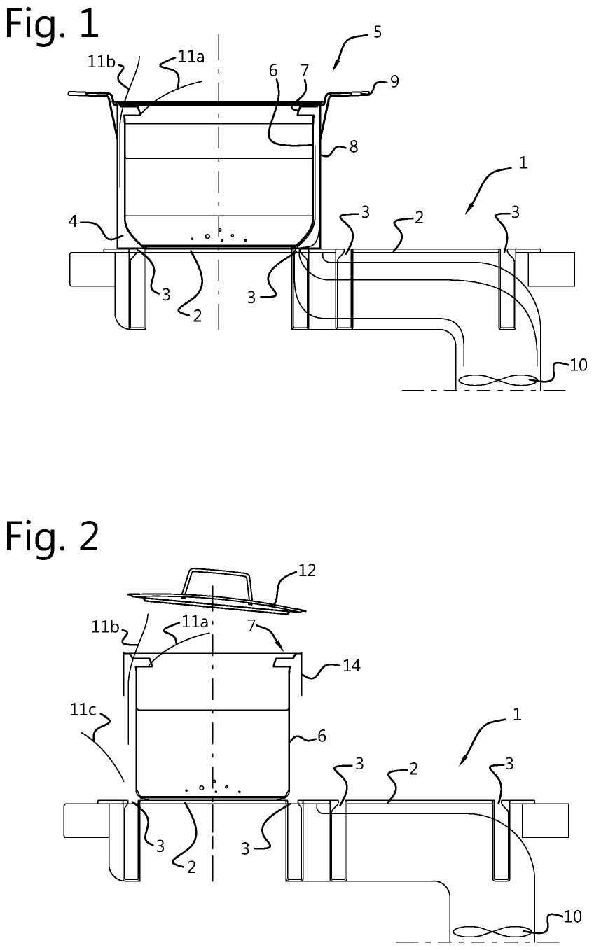

FIG. 1 shows a cross-sectional view of a first embodiment of a combination of an extraction device for a worktop 1 with a pan 5 placed thereon according to the present invention. In the cross-sectional view of FIG. 1, there are two pan supports 2 placed next to one another, for example configured as induction cooking rings (further details of which are omitted from the drawing). Next to each pan support 2, there are one or more associated extraction openings 3, for example in a concentric manner around the pan support 2. The extraction openings 3 are connected to an extraction motor 10 via a duct system.

The pan 5 is placed in the centre of the pan support 2, and in this form a lower edge of an inner pan 6 precisely adjoins the extraction openings 3. The pan 5 is further provided with an outer pan 8, as a result of which an extraction duct 4 arises which runs up the side of the pan 5. At the top side, the pan 5 (in addition to the regular handles 9) is provided with an (internal) pan rim 7 (on which a lid 12 can rest), which in this embodiment is provided with openings or slits. As a result, the extraction area displacement element in this embodiment is formed by the combination of the openings in the pan rim 7 and the outer pan 8. As indicated by reference numerals 11a and 11b, cooking vapours can now be discharged from the inside of the pan 5 and from the area just above the pan 5 towards the extraction motor 10 via the extraction area displacement element 8 and the extraction opening 3.

In general, cooking vapours which normally rise upwards are extracted by creating a low pressure. The more air the extraction motor 10 displaces, the greater the range of the extraction. By providing the pan 5 (or lid) with the extraction area displacement element 8, the required range of the extraction device 1 is reduced. Due to the extraction area displacement element 8, the cooking vapours do not need to be deflected completely over the rim of the pan 5 towards the extraction opening 3 and a range of the extractor device 10 extending up to the openings/slits in the pan rim 7 is sufficient. This leads to a considerable reduction in the required capacity of the extraction device.

As stated above, the present invention can be implemented as a modification of an existing pan design. In general terms, a second aspect of the present invention therefore relates to a pan 5 for use with an extraction device for a worktop as defined above, wherein the pan 5 comprises an extraction area displacement element 7, 8; 14; 15; 16 which is configured to move an active extraction area of the extraction opening 3 to a rim of the pan 5 placed on the pan support 2 during operation. The pan 5 further comprises a pan rim 7 connected to an inside of the pan 5, wherein the pan rim 7 is hollow and is provided with one or more extraction openings, and wherein the pan rim 7 is part of the extraction area displacement element. The one or more extraction openings may be directed towards an inside of the pan 5 and, additionally or alternatively, towards an area above a rim of the pan 5. In the exemplary embodiment shown in FIG. 1, the extraction area displacement element is completed in that it further comprises an outer pan 8 which is connected at a top side to the pan rim 7. The outer pan 8 may, as illustrated, extend as far as the underside of the pan 5 and be aligned with the extraction openings 3 in the worktop during operation.

The cross-sectional view of FIG. 2 represents a further exemplary embodiment of the pan according to the present invention. Only parts of the extraction area displacement element deviate from the embodiment illustrated in FIG. 1. In this embodiment, the pan comprises an external pan rim 14 on the outside of the pan 5 which is directed towards a base of the pan, wherein the external pan rim 14 is connected at a top side to the (internal) pan rim 7. In the exemplary embodiment shown, the external pan rim 14 extends over the entire periphery of the pan 5, but in a further variant the external pan rim 14 extends over part of the periphery of the pan 5. In the embodiment shown, the external pan rim 14 extends in a height direction of the pan over at least a quarter of a height of the pan. In comparison with the embodiment from FIG. 1, this embodiment requires a less extensive structural adaptation of the pan 5. By moving the extraction point to this height of the pan 5, it is still possible to obtain an adequate extraction effect via the openings or slits in the pan rim 7. An even better effect is obtained in yet further variants, in which the external pan rim 14 extends to, for example, a third or even to half of the height of the pan 5. In this case, too, cooking vapours are extracted from the inside of the pan 5 (flow 11a) and from the area just above the pan 5 (flow 11b). However, part of the capacity of the extraction opening 3 is taken up by extraction from the side of the pan 5 (flow 11c).

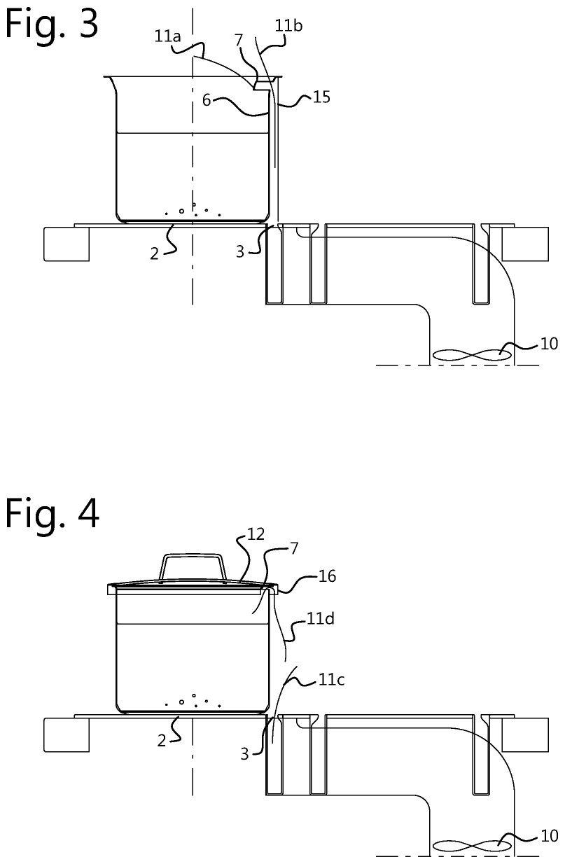

FIG. 3 shows a cross-sectional view of the details of yet a further exemplary embodiment of the pan 5 of the present invention. In this case, the extraction area displacement element (in contrast with the embodiments of FIGS. 1 and 2) is not configured to encircle the entire periphery of the pan 5, but only part of it. In this case, too, cooking vapours are extracted from the inside of the pan 5 (flow 11a) and from the area just above the pan 5 (flow 11b). In this embodiment, the extraction area displacement element further comprises at least one extraction duct 15, which is arranged along part of the periphery of the pan 5. The embodiment shown in FIG. 3 may, for example, be obtained using an extraction area displacement element in the form of one or more extraction attachments which are arranged only partially along the periphery of the pan 5. As described above, embodiments are conceivable in which the one or more extraction attachments are removable, and may optionally be designed for existing pans 5.

FIG. 4 shows a cross-sectional view of a pan 5 according to yet a further embodiment, in which the structural implementation of the extraction area displacement element is simpler. In this embodiment, the extraction area displacement element further comprises a pan rim extension 16 which is directed radially outwards, which induces a deflection of the cooking vapour flow in cooperation with the pan rim 7 and lid 12, as indicated by reference numeral 11d. Together with ambient air (flow 11c), the cooking vapours are then extracted again via the extraction opening 3.

The embodiments shown in FIGS. 1 and 3 may also be used if a lid 12 is used which is placed on the pan rim 7 during cooking. The existing solution is to use a regular lid 12 to prevent the cooking vapours from being able to rise directly, with the result that the cooking vapours escape from between lid 12 and pan rim 7. The range of the extraction motor 10 must then reach as far as the rim of the pan 5 via the extraction opening 3, which is achieved in the embodiments of FIGS. 1 and 3 by means of the outer pan 8, or external pan rim 14, in cooperation with the pan rim 7 which is provided with openings or slits. In both cases, the extraction device for a worktop according to the present invention can extract the cooking vapours from tall pans 5 with a much lower required capacity of the extraction motor 10 either with or without lid 12.

The embodiments of FIGS. 2 and 4 are examples in which the extraction area displacement element is implemented by means of a smaller structural adaptation (extra duct), in other words by means of extraction duct 15, or pan rim extension 16. These variants of the extraction area displacement element deflect the cooking vapours over the rim of the pan 5 in a downwards direction. This reduces the required capacity of the extraction device for a worktop (specifically of extraction motor 10). In these cases, it is advantageous to use a lid 12 to prevent the cooking vapours from rising above the pan 5 and not being extracted.

By using the pan 5 to implement the extraction area displacement element as an elongation (or effectively displacement) of the extraction opening 3 in the worktop (the hob), it is in fact possible for extraction to occur in the pan 5 itself, thus closer to the cooking vapours. As a result, a smaller extraction force is needed to suck the cooking vapours out of/above the pan 5 into the extraction device for a worktop. With a pan 5 according to the present invention, it has been shown that a fifth of the maximum capacity of existing extraction devices is sufficient for the extraction device for a worktop (if no lid 12 is used, a capacity of 120 m3/h was found to be sufficient for each extraction opening 3 of a, for example 4-ring, hob). It is then possible to achieve effective extraction, even in the case of tall pans, without using a lid 12. With a lid 12 used, a twentieth of the maximum capacity of existing extraction devices would even be sufficient (in that case even a capacity of 25-50 m3/h was found to be sufficient). Due to the low capacity required, the noise level produced by the extraction motor 10 is very low. In addition to the effective extraction of all cooking vapours, the limited noise level is an important advantage for the consumer, as this has a direct influence on the experience in the kitchen.

In yet a further embodiment of the extraction device for a worktop according to the present invention, yet a further saving on consumption and lower noise production is achieved. The extraction device for a worktop then further comprises, for each of the at least one pan support 2, a pressure sensor which is placed in the associated extraction duct between the extraction opening 3 and the extraction motor 10, and a control valve that is configured to set a fluid flow in dependence on a signal from the pressure sensor. For the extraction device for a worktop according to one of the present embodiments, one extraction opening 3 and extraction duct connected thereto is required per zone of the hob. These extraction ducts come together in a single central duct which is connected to the extraction motor 10. This makes it possible to fully or partially close off the extraction ducts which are not in use. During operation, this creates a closed system of the extraction motor 10 up to the pan(s) 5. Such a closed system makes it possible for the extraction, even each extraction opening 3, to respond to changes, such as placing a lid 12 on a pan 5, by using the pressure sensor to measure the resistance on the system (pressure loss).

In the extraction device for a worktop, there may be yet further elements present upstream of the central duct or in each separate extraction duct. Examples include a filter unit (for filtering the extracted air, for example a grease filter or a filter containing activated carbon), or liquid collecting and liquid discharging ducts, which are configured to discharge condensed water vapour from the extracted air.

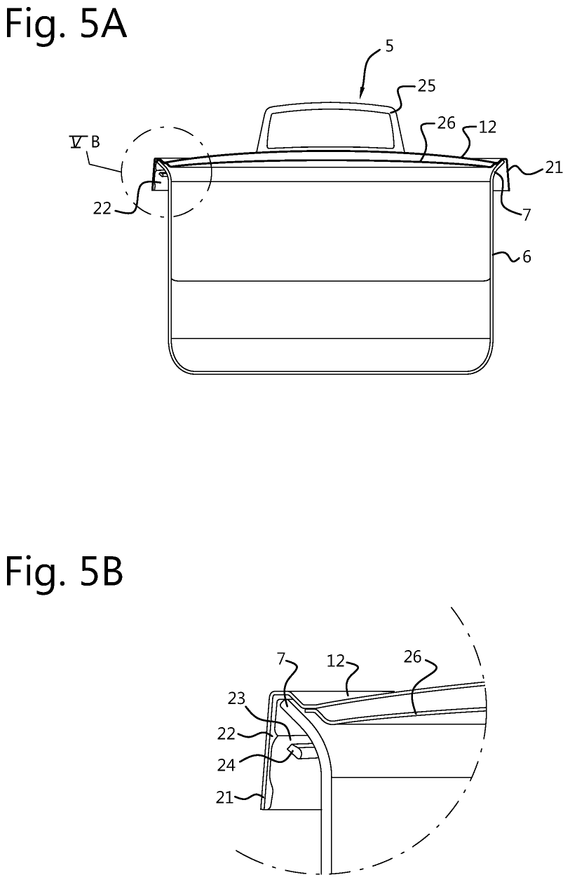

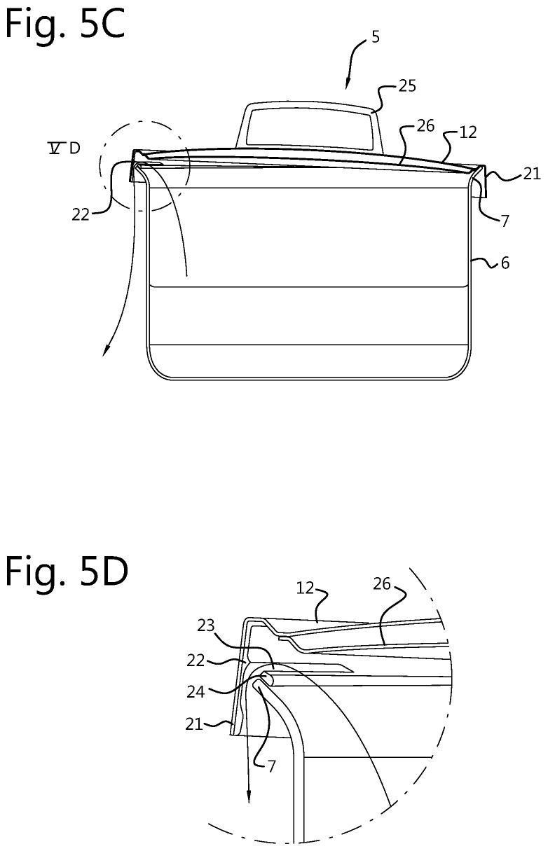

FIG. 5A-D show cross-sectional and detail views of an even further embodiment of a pan 5 usable in one of the present invention embodiments. In this embodiment, a modification of the lid 12 of the pan 5 is used to implement the extraction area displacement element. The lid 12 is shown in this exemplary embodiment as having a handle 25 and a lower lid part 26, in combination with an extended and downward facing rim 21. More in particular a (circumferential) downward extending rim 21 of the lid 12 of the pan 5 is provided in combination with a lid raising part 22. The lid raising part 22 spans a part of an inner circumference of the lid 12 and is provided with at least one aperture 23 near the downward extending rim 21. FIGS. 5A and 5B show the pan configuration wherein the lid 12 is kept in a normal use position, that is flat on the pan 5. In the detail views of FIGS. 5B and 5D it is shown that the lid raising part 22 is provided with an inward directed member 24, as well as with an aperture 23. FIGS. 5C and 5D provide a view on the position wherein the lid raising part 22 is used to keep the lid 12 in a skewed position, allowing cooking fumes and vapour to escape between the rim 7 of the pan 5 and the lid 12, i.e. through the open channel provided by the inward directed member 24 and the at least one aperture 23, as indicated by the long arrow line in FIG. 5C.

As shown, the inward directed member 24 of the lid raising part 22 is positioned at a predetermined vertical distance from the bottom of the lid 12, allowing the lid 12 to be held in an open position, sufficiently to allow cooking fumes/vapour to escape towards the rim 7 of the pan 5 to be extracted. The lid raising part 22 can be provided as an add on or insert part, e.g. made from a moulded plastic element, e.g. a silicone material. Alternatively, the lid raising part 22 is made of a metal material, e.g. the same or similar as the lid 12 material.

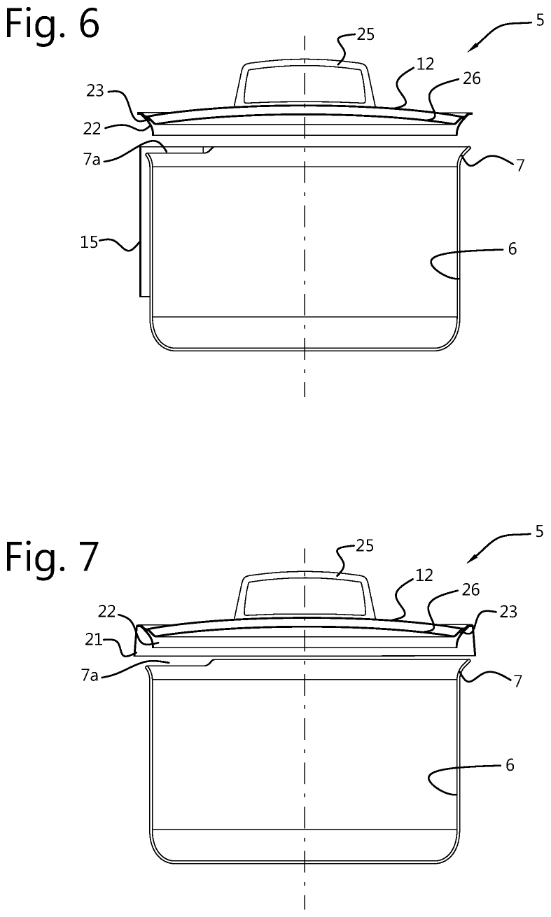

In further exemplary embodiments, also the pan 5 itself is modified to enable proper escape of cooking fumes in the desired direction. In these embodiments, the rim 7 of the pan 5 is provided with a recess 7a over part of the circumference of the rim 7 (as shown in the cross sectional views of FIGS. 6-8).

In the embodiment shown in FIG. 6, the recess 7a is combined with having the extraction area displacement element further comprising at least one extraction duct 15, which is arranged along part of the periphery of the pan 5 (somewhat similar to the embodiment shown in FIG. 3.

In the embodiments shown in cross sectional view in FIG. 7, the recess 7a in the rim 7 of the pan 5 is combined with a modification of the lid 12 including a lid raising part 22 provided with at least one aperture 23. The lid raising part 22 is in this embodiment symmetric and congruent with the rim of the pan 5, and is used to actually raise the lid 12, or better the lower lid part 26, sufficiently to allow opening 23 to be registered with recess 7a if it is desired to allow cooking fumes to escape from the pan 5 with lid 12. Furthermore, it is shown that in this embodiment, the extraction area displacement element further comprises a downward extending rim 21 of the lid 12.

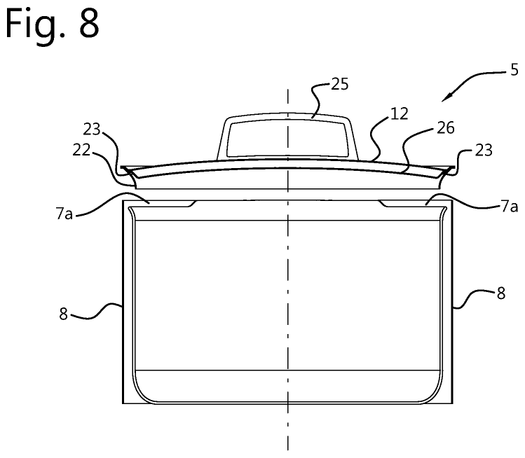

The exemplary embodiment shown in cross sectional view in FIG. 8 in addition implements the extraction area displacement element by adding an outer pan 8 which is connected at a top side to the rim 7. This exemplary embodiment is furthermore provided with multiple recesses 7a a the rim 7 of the pan 5, and correspondingly multiple apertures 23 in the lid raising part 22. This would e.g. allow to have a higher volume of cooking fumes escape from the pan 5 and lid 12 combination, and being extracted using the present invention combination of extraction device for a worktop and a pan 5.

The present invention is described above with reference to a number of exemplary embodiments which are shown in the figures. Modifications and alternative implementations of parts and elements are possible, and are considered to fall within the scope of protection as defined in the attached claims.

1. A combination of an extraction device for a worktop and a pan,
the extraction device comprising a worktop having at least one pan support for supporting the pan, wherein the worktop further comprises an extraction opening which is provided in a main surface of the worktop and arranged close to the at least one pan support, and an extraction motor in communication with the extraction opening via an associated extraction duct and arranged to provide an area of low pressure in the extraction opening for extracting cooking fumes,
further comprising an extraction area displacement element which, when the pan is placed on the pan support during operation, is configured to move the area of low pressure to an area near a rim of the pan or configured to direct cooking fumes from the rim of the pan towards the area of low pressure.

2. The combination according to claim 1, wherein the extraction area displacement element comprises a duct like assembly in communication with the extraction opening.

3. The combination according to claim 1, wherein the extraction area displacement element comprises a redirection body arranged to redirect cooking fumes from the rim of the pan towards the extraction opening.

4. The combination according to claim 1, wherein the extraction area displacement element is an integral part of the pan.

5. The combination according to claim 1, wherein the extraction area displacement element is a separate part.

6. The combination according to claim 1, wherein the extraction device for a worktop further comprises, for each of the at least one pan support:
a pressure sensor which is placed in the associated extraction duct between the extraction opening and the extraction motor, and
a control valve that is configured to set a fluid flow in dependence on a signal from the pressure sensor.

7. The combination according to claim 1, wherein the worktop comprises two or more pan supports, and a single extraction opening is provided in the surface of the worktop symmetrically in between the two or more pan supports.

8. The combination according to claim 1, wherein the pan comprises a pan rim connected to an inside of the pan, wherein the pan rim is provided with one or more extraction openings, and the pan rim is part of the extraction area displacement element.

9. The combination according to claim 8, wherein the one or more extraction openings are directed towards an inside of the pan.

10. The combination according to claim 8, wherein the one or more extraction openings are directed towards an area above a rim of the pan.

11. The combination according to claim 8, wherein the extraction area displacement element further comprises an outer pan which is connected at a top side to the pan rim.

12. The combination according to claim 8, wherein the extraction area displacement element further comprises an external pan edge directed towards a base of the pan, which external pan edge is connected at a top side to the pan rim.

13. The combination according to claim 12, wherein the external pan edge extends in a height direction of the pan over at least a quarter of a height of the pan.

14. The combination according to claim 8, wherein the extraction area displacement element further comprises at least one extraction duct, which is arranged along part of the periphery of the pan.

15. The combination according to claim 8, wherein the extraction area displacement element comprises a lid edge extension which is directed radially outwards.

16. The combination according to claim 1, wherein the extraction area displacement element is formed by a downward extending rim of a lid of the pan and a lid raising part,
wherein the lid raising part spans a part of an inner circumference of the lid and is provided with at least one aperture near the downward extending rim.

17.-18. (canceled)

19. The combination according to claim 1, wherein the rim of the pan is provided with a recess over part of the circumference of the rim.

20. The combination according to claim 19, wherein the extraction area displacement element further comprises at least one extraction duct, which is arranged along part of the periphery of the pan.

21. The combination according to claim 19, wherein the extraction area displacement element further comprises a downward extending rim of the lid.

22. The combination according to claim 19, wherein the extraction area displacement element further comprises an outer pan which is connected at a top side to the rim.
